(19) United States
(12) Patent Application Publication
(10) Pub. No.: US 2020/0080283 A1
(43) Pub. Date: Mar. 12, 2020

(54) UNDERWATER TRENCHER HAVING SUBMARINE CABLE BURYING APPARATUS

(71) Applicant: KOREA INSTITUTE OF OCEAN SCIENCE & TECHNOLOGY, Busan (KR)

(72) Inventors: Changjoo SHIN, Busan (KR); Osoon KWON, Suwon-si (KR); Jungmin SEO, Busan (KR); Hyoun KANG, Busan (KR); Jiwon PARK, Daegu (KR); Doseoung KIM, Daegu (KR)

(21) Appl. No.: 16/250,617

(22) Filed: Jan. 17, 2019

(30) Foreign Application Priority Data
Sep. 7, 2018 (KR) 10-2018-0107246

(51) Int. Cl. E02F 5/06; H02G 1/10; E02F 9/08

(52) U.S. Cl. CPC E02F 5/06; E02F 9/08; H02G 1/10

(57) ABSTRACT

The underwater trencher includes an underwater moving body, and a trench digger provided in the underwater moving body by a support plate and a cutter support provided on an upper surface of the underwater moving body; a cable guide member configured to guide the submarine cable to a trench excavated by the trench digger is coupled to the cutter support; and an upwardly opened guide portion of the cable guide member is provided with a depressor configured to press downwards the submarine cable drawn into and guided by the cable guide member or to release a pressing force so as to relax a tensioned state of the submarine cable when tension is generated in the submarine cable.

### BACKGROUND

### 1. Field

The present disclosure relates to an underwater trencher having a submarine cable burying device.

### 2. Description of the Related Technology

In general, a submarine cable burying machine refers to an apparatus used to establish communication or power lines in land and island areas, or to bury long-distance oil pipelines and water pipes extending via sea, on the seafloor. Korean Patent No. 10-0576101 (published on May 3, 2006) discloses an apparatus for excavating a seafloor and burying a submarine cable.

### SUMMARY

An aspect of the present disclosure is to provide an apparatus for carrying out excavation under a hard soil and soft rock condition of a submarine ground, and performing a burying operation of a submarine cable.

Another aspect of the present disclosure is to provide an apparatus capable of: supporting a submarine cable such that the submarine cable does not float by buoyancy, tidal current, or other external force when the submarine cable is buried in the submarine ground; and controlling the pressing force to press the submarine cable based on a load acting on the submarine cable.

Still another aspect of the present disclosure provides an underwater trencher having a submarine cable burying device, in which the submarine cable burying apparatus includes a depressor capable of: performing an excavation operation and an operation of burying a pipeline, a submarine cable, or the like under the hard soil and soft rock condition of submarine ground; and preventing the pipeline, submarine cable, or the like from floating due to buoyancy, tidal current, or other external force; and controlling a pressing force.

Aspects of the present disclosure are not limited to the aforementioned ones, and other unmentioned aspects of the present disclosure will be clearly understood from the following description by those skilled in the art to which the present disclosure pertains.

The above aspects are achieved by an underwater trencher having a submarine cable burying apparatus, which is characterized in that: the underwater trencher includes an underwater moving body, and a trench digger provided in the underwater moving body by a support plate and a cutter support provided on an upper surface of the underwater moving body; a cable guide member configured to guide the submarine cable to a trench excavated by the trench digger is coupled to the cutter support; and an upwardly opened guide portion of the cable guide member is provided with a depressor configured to press downwards the submarine cable drawn into and guided by the cable guide member or to release a pressing force so as to relax a tensioned state of the submarine cable when tension is generated in the submarine cable.

A pair of upper cutter support pieces may be disposed on an upper surface of one end of the support plate such that the cutter support and a support frame of the trench digger are coupled by a shaft thereto, and a pair of lower cutter support pieces may be disposed on a bottom surface of the one end of the support plate such that remaining ends of couple cutter actuators, one ends of which are respectively coupled to opposite sides of the cutter support, are coupled thereto in order to adjust an angle of the trench digger upwards or downwards with reference to the shaft.

At one side of the inlet of the cable guide member, an opening may be formed by removing or bending a side wall in order to connect and disconnect the submarine cable when the submarine cable has been drawn into the inlet or while the submarine cable C is being drawn into the inlet.

The depressor may include: a push member having one end coupled by a shaft to an upper portion at a side of the inlet of the guide portion and a remaining end as a free end, which turns upwards or downwards within a set angle with reference to the shaft, the push member being formed to have a length equal to or longer than a length of the cable guide member; and a plurality of push rollers provided on a bottom surface of the push member so as to reduce a frictional force between the push member and the submarine cable drawn into the guide portion and to press the submarine cable downwards.

The depressor may include a pressing unit configured to relax the tension of the submarine cable supported by the push rollers by raising the push member about the shaft or to tighten the tension of the submarine cable supported by the push rollers by lowering the push member.

The pressing unit may include: an actuator, one end of which is coupled by a shaft to the cable guide member and a remaining end is coupled by a shaft to the push member to operate to raise or lower the push member about the shaft; and a load sensing sensor provided in the actuator. The load sensing sensor is configured to: generate a sensing signal for causing the actuator to operate to raise the push member by sensing tension when the tension is generated in the submarine cable by an external force including buoyancy or tidal current; and generate a sensing signal for causing the actuator to operate to lower the push member by sensing relaxation of the tension when the external force is removed and thus the tension is relaxed.

The pressing unit may include a water tank provided at the remaining end of the push member, and provided with an inlet and an outlet each having a valve; and a control unit including an air pump and a water pump configured to: discharge water accommodated in the water tank and introduce air into the water tank when the tension is generated in the submarine cable by an external force including buoyancy or tidal current so as to reduce a weight of the water tank; and to introduce water into the water tank when the tension acting on the submarine cable has been lost so as to increase the weight of the water tank.

Each of the push rollers may be provided with a tension sensing sensor configured to sense a load applied to a shaft of the push roller when the external force acts on the submarine cable and the control units performs control based on the sensing signal output from the tension sensing sensor.

A guide member may be provided on an upper surface of the underwater moving body, the guide member having a guide hole configured to support and guide the submarine cable to the guide portion.

According to the present disclosure, it is possible to perform excavation under a hard soil and soft rock condition of a submarine ground and to perform an operation of burying a pipeline or a submarine cable.

In addition, when burying a pipeline or a submarine cable in a submarine ground, it is possible to stably bury the pipeline or the submarine cable by supporting the pipeline or the submarine cable using the depressor such that the pipeline or submarine does not float by an external force such as buoyancy, tidal current, or the like.

In addition, when an external force including buoyancy or tidal current is generated and tension is generated in a pipeline or a submarine cable, it is sensed and the pressing force is released. When the tension is lost, the pressing force is applied again. Thus, it is possible to prevent the pipeline or the submarine cable from being damaged due to excessive tension.

### BRIEF DESCRIPTION OF THE DRAWINGS

The above and other aspects, features and advantages of the present disclosure will be more apparent from the following detailed description taken in conjunction with the accompanying drawings, in which:

FIGS. 1 and 2 are schematic views illustrating a submarine cable burying apparatus according to the prior art;

FIG. 3 is a schematic perspective view illustrating an underwater trencher having a submarine cable burying apparatus according to a first embodiment of the present disclosure;

FIG. 4 is a perspective view illustrating the support plate and the cutter support illustrated in FIG. 3;

FIG. 5 is a partially enlarged side view illustrating a connection portion of the trench digger and the underwater moving body;

FIGS. 6 and 7 are a schematic perspective view and a block diagram illustrating the depressor illustrated in FIG. 3;

FIGS. 8 and 9 are schematic side views for explaining the operation of the depressor illustrated in FIG. 3; and

FIGS. 10 and 11 are a schematic perspective view and a block diagram for explaining an underwater trencher having a submarine cable burying apparatus according to a second embodiment of the present disclosure.

### DETAILED DESCRIPTION OF EMBODIMENTS

Hereinafter, embodiments of the present disclosure will be described in detail with reference to the accompanying drawings. In the description of the present disclosure, the description of the well-known function or structure will be omitted in order to clear the subject matter of the present disclosure.

The terms as used herein are merely for the purpose of describing embodiments and are not intended to limit the present disclosure. As used herein, singular forms are intended to include plural forms unless the context clearly indicates otherwise. The terms “comprises” and/or “comprising” as used herein refer to the existence of a disclosed element, and do not exclude the existence or addition of one or more other elements.

A submarine cable burying machine may include: a submersible provided with a self-generator and other control devices, an underwater pump having an air compressor, a cable drum, and the like, and a hydraulic cylinder; and an excavator provided with a water-jet nozzle connected to an underwater pump of the submersible so as to excavate the plowed seafloor.

The submarine cable burying machine configured as described above primarily excavates the submarine ground with a trench digger provided in the submersible, performs excavation on the excavated seafloor with a strong jetting force through the water-jet nozzle connected to the submersible pump, and then buries a submarine cable in that place.

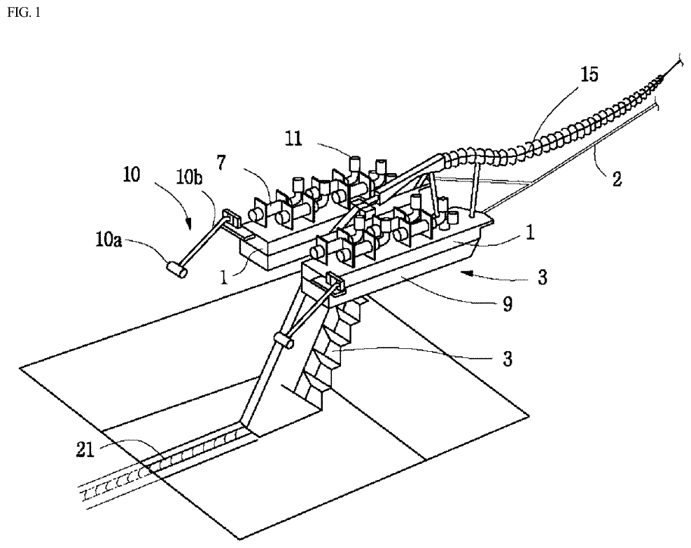

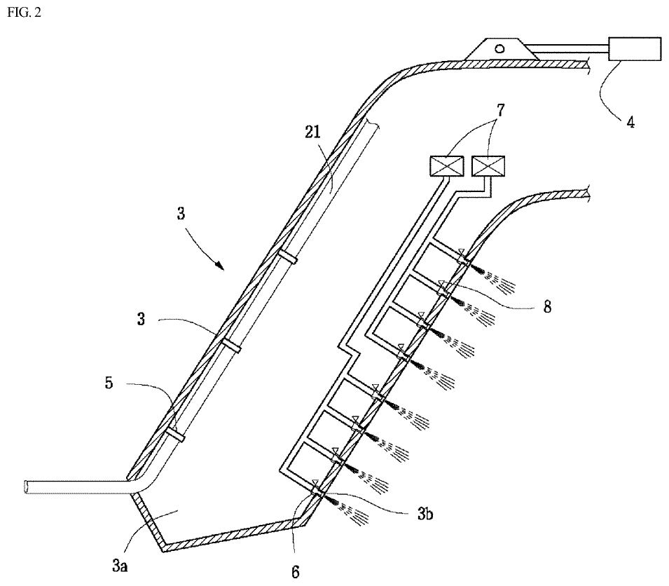

Referring to FIG. 1, the apparatus includes: two ballasts 1 connected to a traction rope 2 drawn out and diverged from a cable laying vessel and submerged; a scraper 3 installed in the middle portion between the two ballasts 2 and having an inner space portion 3a configured to receive and draw out a submarine line and a plurality of discharge ports 3b provided in the inner surface in the direction of travel of the cable laying vessel so as to scrape excavated rock debris or sand soil; a hydraulic cylinder 4 hinged to the scraper 3 so as to vary the turning angle of the scraper 3; a guide support member 5 provided on the other side of the inner space portion 3a of the scraper so as to guide the submarine line 21 such that the submarine line 21 is pulled out to the excavated seafloor through the scraper 3 without twisting or flowing due to the influence of tidal current; a plurality of water jet high-pressure nozzle pumps 6, which are respectively connected to the discharge ports 3b of the scraper 3 so as to jet water at a high pressure; a pressure pump 7 mounted on one side of the upper surface of the ballast 1 and connected to a suction portion of the water jet high-pressure nozzle pump 6 to provide a predetermined jetting pressure thereto; a nozzle sensor 8 connected to each of the plurality of water jet high-pressure nozzle pumps 6 so as to sense them when they are not operating and to provide a driving signal to the pressure pump 7 such that the water jet high-pressure nozzle pumps 6 are automatically pressed; a buoyancy tank 9 provided on the bottom surface of the ballast 1 so as to adjust the balance thereof; a level sensing sensor 10 provided at the tail end of the ballast 1 so as to detect the curved state of the seafloor; and an air pump 11 mounted on the other side of the upper surface of the ballast 1 so as to introduce air into the buoyancy tank 9.

Such a burying apparatus uses a water-jet apparatus that provides a high-pressure jetting force to quickly and smoothly perform excavation irrespective of the soil of the seafloor including soft rock, hard rock, and sandy soil, and buries a submarine cable in the excavated seafloor.

However, since the burying apparatus having this structure is configured to excavate a trench using only air pressure, the excavation efficiency is lowered and since a unit for supporting a cable is not provided, it is impossible to stably maintain the tension acting on the cable when various external forces (movements caused by buoyancy, tidal current, waves, and the like) act on the cable, whereby the cable is damaged.

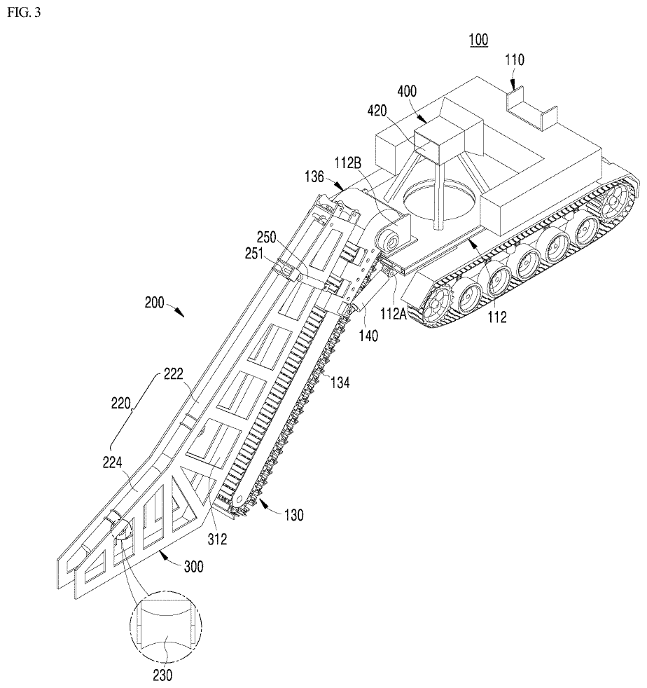

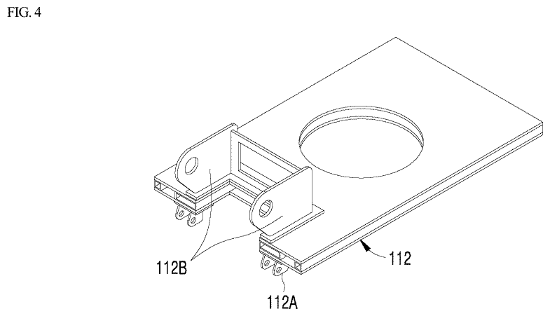

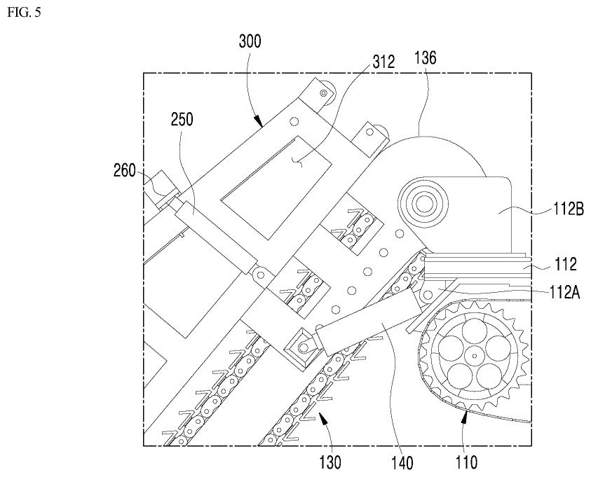

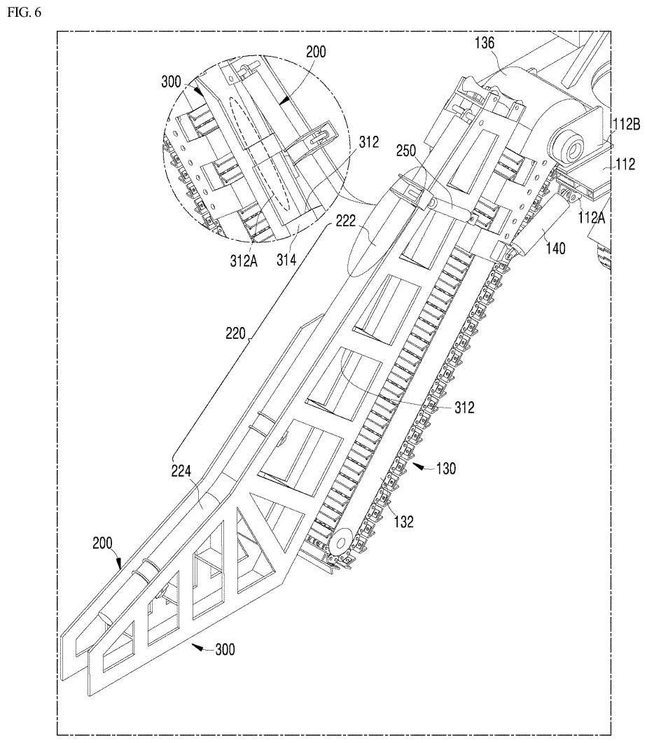

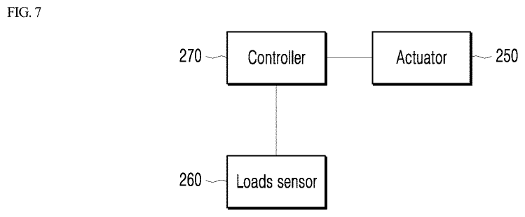

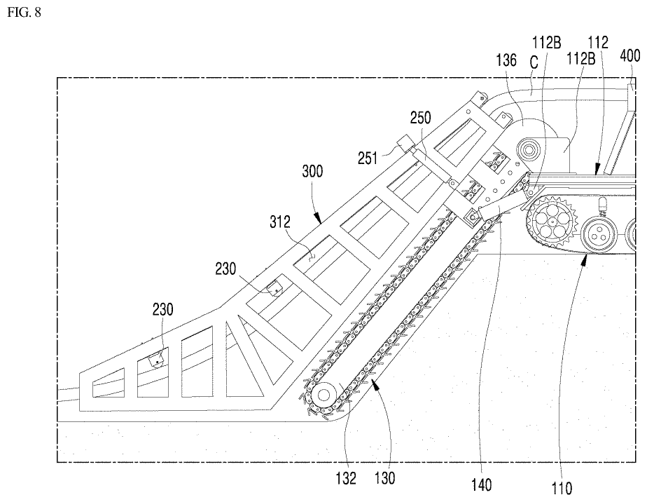

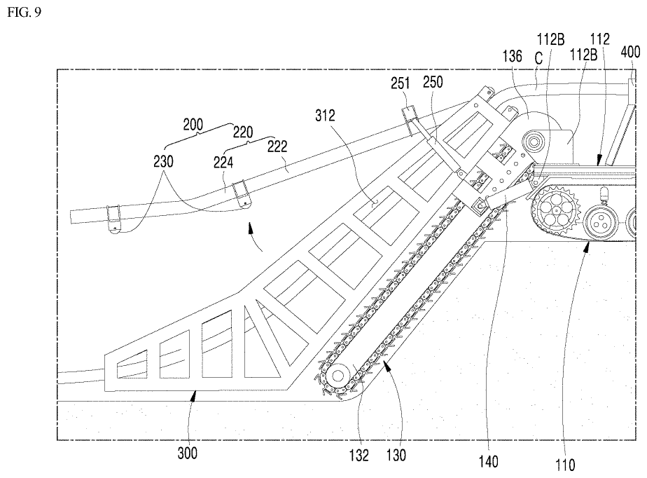

In the accompanying drawings, FIG. 3 is a schematic perspective view illustrating an underwater trencher having a submarine cable burying apparatus according to a first embodiment of the present disclosure, FIG. 4 is a perspective view illustrating the support plate and the cutter support illustrated in FIG. 3, and FIG. 5 is a partially enlarged side view illustrating a connection portion of the trench digger and the underwater moving body. In addition, FIGS. 6 and 7 are a schematic perspective view and a block diagram illustrating the depressor illustrated in FIG. 3, and FIGS. 8 and 9 are schematic side views for explaining the operation of the depressor illustrated in FIG. 3.

As illustrated in FIGS. 3 to 8, in embodiments, an underwater trencher 100 having a submarine cable burying apparatus according to the present disclosure may be used for burying a pipeline or a submarine cable C under a hard soil and under soft rock condition of the submarine ground. The underwater trencher 100 includes an underwater moving body 110 having an endless track-based moving unit, and a trench digger 130 provided on the underwater moving body 110 by a support plate 112 and a cutter support 114 provided on the upper surface of the underwater moving body 110. In addition, the underwater trench 100 includes a submarine cable burying apparatus composed of a cable guide member 300 and a depressor 200 configured to bury a pipeline or a submarine cable C in a trench excavated by the trench digger 130.

On the upper surface of the underwater moving body 110, a guide member 400 including a guide hole 420 is provided to stably guide the pipeline or the submarine cable C to the guide portion 312 of the cable guide member 300 and to support the pipeline or the submarine cable C without bending. This guide member 400 is to stably guide the submarine cable C supplied from a cable burying barge or ship located in the sea to the guide portion 312 of the cable guide member 300 without bending. At this time, a plurality of support rollers are installed inside the guide hole 420.

A pair of upper cutter support pieces 112B are disposed on the upper surface of one end of the support plate 112 so as to couple by a shaft a support frame 132 and a cutter support 136 of the trench digger 130 thereto. On the bottom surface of the one end of the support plate, a pair of lower cutter support pieces 112A is disposed so as to couple by a shaft the other ends of the cutter actuators 140. The one ends of the cutter actuators 140 are coupled by a shaft to the opposite sides of the cutter support 136 so as to adjust the angle of the support frame 132 of the trench digger 130 upwards and downwards with reference to the shaft.

The trench digger 130 includes rotating bodies, which are respectively provided at the opposite ends of the support frame 132 formed to have a predetermined length, and a hydraulic motor is installed in the rotating body located at the side of the upper cutter support pieces 112B. The hydraulic motor is configured to drive the rotating bodies. As the rotating bodies are driven by the hydraulic motor, the endless track-based cutter 134 including a large number of tips and provided on the support frame 132 is capable of excavating a trench in the submarine ground while being rotated. Since the trench digger 130 is well-known in the art, a detailed description thereof will be omitted.

Meanwhile, the cutter support 136 is coupled to enclose one side of the support frame 132 at a position where the hydraulic motor is installed, and supports the other end of each of the cutter actuators 140 described above. Further, on one upper surface of the cutter support 136, one region (upper end region) of the cable guide member 300 including the depressor 200 is coupled.

The cable guide member 300 is for guiding a pipeline or a submarine cable C to the trench excavated by the trench digger 130 in the seafloor ground, and the upper end region of the cable guide member 300 is fixedly coupled to the upper surface of the cutter support 136. As illustrated in FIGS. 3 and 6, the cable guide member 300 includes a guide portion 312, which is provided between a pair of grid-shaped supports formed to be elongated in the longitudinal direction thereof such that the submarine cable C is received and guided through the guide portion. The guide portion 312 has a structure that is opened upwards in the longitudinal direction. The length of the cable guide member 300 is longer than the length of the trench digger 130, and the lower end portion thereof extends in the horizontal direction. The lower end portion extending in the horizontal direction is positioned above the trench formed by the trench digger 130. This structure is provided so as to stably guide the submarine cable C to the trench formed by the trench digger 130.

Meanwhile, at one side of the inlet of the cable guide member 300, an opening 312A is formed by removing or bending the side wall 314 in order to connect and disconnect the submarine cable C when the submarine cable C has been drawn into the inlet or while the submarine cable C is being drawn into the inlet. In embodiments, as illustrated in FIG. 6, the side wall 314 constituting the inlet-side guide portion 312 is removed or inwardly bent, and thus the opening portion 312A, which opens laterally, is provided. It is possible to facilitate the operation of connecting or disconnecting the submarine cable C through the opening 310.

The depressor 200 is provided so as to press downwards the submarine cable C drawn into and guided by the guide portion 312 of the cable guide member 300 such that the submarine cable C does not float by buoyancy or tidal current, and to release the pressing force that presses the submarine cable C downwards when a tension occurs in the submarine cable C so as to relax the cable C. The depressor 200 is installed in the upwardly opened guide portion 312 of the cable guide member 300.

The depressor 200 is formed of a rod or pipe having a predetermined length. The depressor 200 is formed to have the same length and shape as the cable guide member 300. The deflector 200 includes: a push member 220 having one end coupled by a shaft to the inlet side upper portion of the guide portion 312 and a remaining end as a free end, which turns upwards or downwards within a set angle with reference to the shaft, the push member 220 being formed to have a length equal to or longer than that of the cable guide member 300; and a plurality of push rollers 230 provided on the bottom surface of the push member 220 so as to reduce a frictional force between the push member 220 and the submarine cable C drawn into the guide portion 312 and to press the submarine cable C downwards.

The push member 220 has a straight portion 222, one end of which is coupled by a shaft to the side wall 314 at the inside of the guide portion 312, and a lower end extension 224 extending in the state of being bent at the lower end of the straight portion 222 at the same angle as the lower end portion of the cable guide member 300. The push member 220 having such a structure can be lifted upwards about the shaft.

Meanwhile, the depressor 200 includes a pressing unit configured to relax the tension of the submarine cable C supported by the push rollers 230 by raising the push member 220 about the shaft or to tighten the tension of the submarine cable C supported by the push rollers 230 by lowering the push member 220.

As illustrated in FIGS. 3, 5, 8, and 9, the pressing unit includes: an actuator, one end of which is coupled by a shaft to the cable guide member 300 or the cutter support 136 and the other end is coupled by a shaft to a connection bracket 251 coupled to the push member 220 to operate to raise or lower the push member 220 about the shaft; and a load sensing sensor 260 provided in the actuator 250 or the connection bracket 251, the load sensing sensor being configured to: generate a sensing signal for causing the actuator 250 to operate to raise the push member 220 by sensing tension when the tension is generated in the submarine cable C by an external force including buoyancy or tidal current; and generate a sensing signal for causing the actuator 250 to operate to lower the push member 220 by sensing relaxation of the tension when the external force is removed and thus the tension is relaxed.

The load sensing sensor 260 is preferably installed between the connection bracket 251 and an actuating rod of the actuator 250. The load sensing sensor 260 is provided to measure the magnitude of the tension resulting from an external force acting on the submarine cable C supported by the push member 220. The load sensing sensor 260 may be configured in various ways. In the present embodiment, a description will be made with reference to a load sensing sensor constituted with a load cell configured to sense a load and to generate an electrical load.

As illustrated in FIG. 7, the pressing unit includes a control unit 270 configured to control the operation of the actuator 250 on the basis of a magnitude sensing signal of the tension sensed by the load sensing sensor 260. The control unit 270 is configured to: compare a magnitude value of tension sensed by the load sensing sensor 260 with the magnitude value of the tension stored in the memory. When the magnitude value sensed by the load sensing sensor 260 is larger, the controller determines that tension is generated in the submarine cable C and operates the actuator 250 to raise the push member 220, thereby relaxing the tension of the submarine cable C. When the magnitude value of the tension sensed by the load sensing sensor 260 is smaller, the control unit determines that the tension has been lost and operates the actuator 250 to lower the raised push member 220, thereby pressing the submarine cable C.

The operation of the underwater trencher 100 having the submarine cable burying apparatus configured as described will be described.

As illustrated in FIG. 8, in the state in which the trench digger 130 is provided in the underwater moving body 110 and the cable guide member 300 having the depressor 200 is provided to the cutter support 136, when the underwater moving body 110 is placed on the submarine ground, a pipeline or a submarine cable C is drawn into the guide portion 312 of the cable guide member 300 through the guide hole 420.

In the state in which the submarine cable C is drawn into the guide portion 312, the push member 220 presses the submarine cable C downwards such that the submarine cable C does not float by buoyancy force.

In the state in which the submarine cable C is drawn into the cable guide member 300, the trench digger 130 excavates the submarine ground while being rotated by the hydraulic motor to form a trench in order to bury the submarine cable C therein, and at the same time, the underwater moving body 110 moves in a direction in which no trench is formed. In this process, a trench for burying the submarine cable C, which has a predetermined depth and width, is formed on the submarine ground.

When the underwater moving 110 moves while forming a trench in the submarine ground, the submarine cable C drawn into and guided by the cable guide member 300 can be buried in the trench.

In the process of burying the submarine cable C guided by the cable guide member 300 into the trench formed by the trench digger 130 of the underwater moving body 110 as described above, when tension is applied to the submarine cable C due to an external force including buoyancy, tidal current or the like, the load sensing sensor 260 of the pressing unit senses the tension.

In embodiments, in the state in which the actuator 250 pulls the push member 220 downwards and the push member 220 presses the submarine cable C located in the guide portion 312 downwards, when an external force acts on the submarine cable C and the tension increases, a force to raise the pressing member 220 upwards is generated, and the load sensing sensor 260 senses the force and generates a tension sensing signal.

When the load sensing sensor 260 senses the tensioned state of the submarine cable C, that is the tension generated in the submarine cable C due to various external forces, the control unit 270 controls the actuator 250 to raise the push member 220, which has been pressing the submarine cable C, as illustrated in FIG. 9. As the actuator 250 raises the push member 220, the force that presses the submarine cable C downwards is lost, and thus the tension state of the submarine cable C is relaxed.

As described above, when the tension equal to or greater than a set value is generated in the submarine cable C, the load sensing sensor 260 senses the tension and raises the push member 220, which has been pressing the submarine cable C so as to relax the tensioned state of the submarine cable C, so that it is possible to minimize or prevent the breakage of the submarine cable C or the damage of the apparatuses that support the submarine cable C due to the excessive tension.

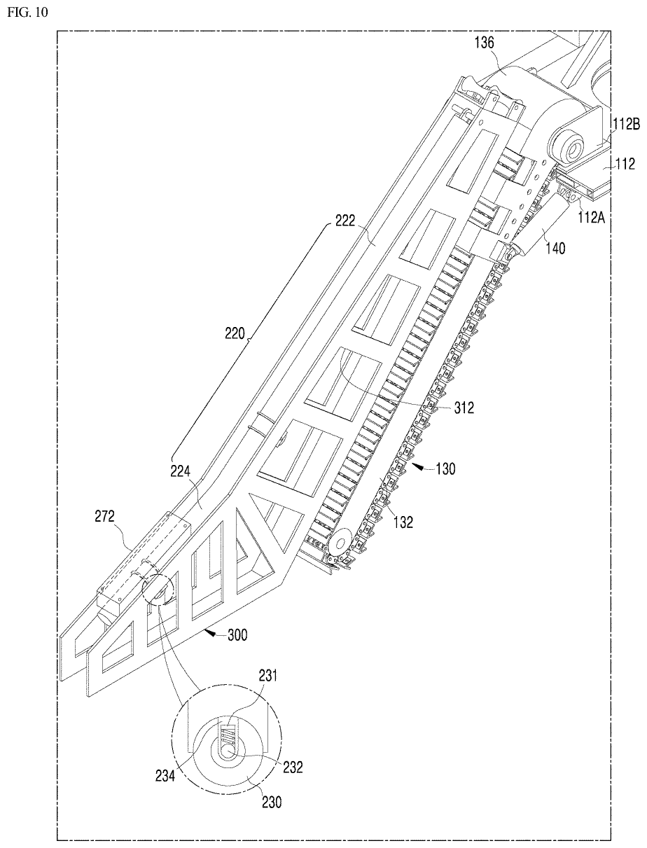

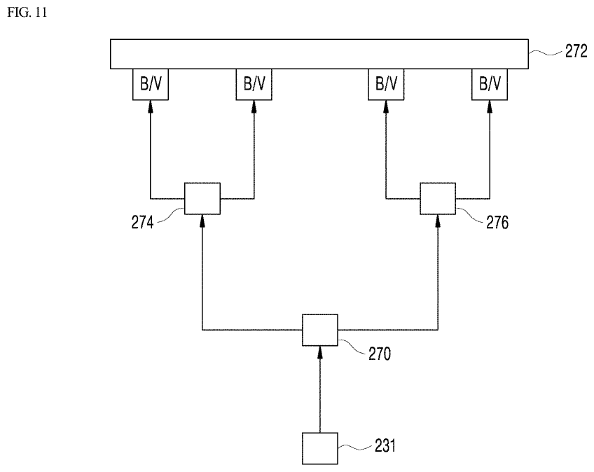

In the accompanying drawings, FIGS. 10 and 11 are a schematic perspective view and a block diagram for explaining an underwater trencher having a submarine cable burying apparatus according to a second embodiment of the present disclosure.

As illustrated in FIGS. 10 and 11, an underwater trencher 100 having a submarine cable embedding device according to the second embodiment is the same as the above-described underwater trencher, except that the pressing unit configured to pressing the submarine cable C or to release the pressed state includes a water tank 272 and a control unit 270 configured to control the weight the water tank 272 by sensing the tension acting on the submarine cable C.

This will be explained in more detail.

The pressing unit includes: a water tank 272 provided at the other end of the push member 220 and provided with an inlet and an outlet each having a valve B/V, and a control unit 270 including an air pump 274 and a water pump 276, in which the air pump 274 and the water pump 276 are configured to: discharge water accommodated in the water tank 272 and introduce air into the water tank 272 when the tension is generated in the submarine cable C by an external force including buoyancy or tidal current so as to reduce the weight of the water tank 272; and to introduce water into the water tank 272 when the tension acting on the submarine cable C has been lost so as to increase the weight of the water tank 272.

As illustrated in FIG. 10, the water tank 272 is provided in the lower end extension 224 of the push member 220 and includes an air inlet and an air outlet, which are provided with air introduction and discharge valves B/V, respectively, and a water inlet and a water outlet, which are provided with water introduction and discharge valves B/V, respectively. Pipelines connected to respective inlets and outlets are provided with an air pump 274 for air introduction and discharge and a water pump 276 for water introduction and discharge, respectively.

Meanwhile, a tension sensing sensor 231 is installed on each of the push rollers 230 provided on the bottom surface of the lower end extension 224. In embodiments, a tension sensing sensor 231 made of a load cell is provided inside a shaft bracket 234 that supports the shaft 232 of each the push roller 230 so as to sense a load transmitted to the shaft 232. The tension sensing sensor 231 is configured to sense a load acting on the shaft 232 when tension is generated in the submarine cable C and thus a load is applied to the shaft 232 of the push roller 230 and a shock-absorbing spring is slightly compressed.

In the state in which tension is not generated in the submarine cable C, that is, the submarine cable C is not tensioned, the control unit 270 operates the water pump 276 to introduce water into the water tank 272. Therefore, the weight of the water tank 272 increases, and the push rollers 230 press the submarine cable C downward.

In this state, when the tension is generated in the submarine cable C due to various external forces and thus the submarine cable C is tensioned, a load acts on the shaft 232 of each of the push rollers 230 that press the submarine cable C downward, and the tension sensing sensor 231 senses the load and generates an external force detection signal. The control unit 270 opens the valve B/V of the outlet where water is discharged on the basis of the sensing signal of the tension sensing sensor 231 and operates the air pump 274 so as to cause air to be supplied into the water tank 272. In this process, since the water in the water tank 272 is discharged and the water tank 272 is filled with the air, the weight of the water tank 272 is reduced. Since the weight of the water tank 272 is reduced by this process, the pressing force for pressing the submarine cable C downwards is lost, and the tension state of the submarine cable C can be relaxed.

In this way, by providing the water tank 272 on the lower end extension 224 of the push member 220 and the tension sensing sensor 231 is attached to the shaft 232 of each of the push rollers 230 supporting the submarine cable C such that the control unit 270 controls the operation of the water pump 276 or the air pump 274 on the basis of a tension sensing signal output from the tension sensing sensor 231, when tension is generated in the submarine cable C and thus the submarine cable C becomes tensioned state, the weight of the water tank 272 is reduced so that the tensioned state of the submarine cable C can be relaxed, and when the tension acting on the submarine cable C is lost, it is possible to press the submarine cable C again by introducing water into the water tank 272, thereby increasing the weight of the water tank 272.

As described above, since the underwater trencher 100 including the depressor 200, the cable guide member 300, and the trench digger 130 is provided, a trench for burying a submarine cable C in the submarine ground can be easily excavated, and a pipeline or a submarine cable C guided by the cable guide member 300 and supported by the depressor 200 can be buried simultaneously with excavation of the trench.

Particularly, by providing the deflector 200 capable of supporting and pressing the submarine cable C inside the cable guide member 300 or releasing the pressing force, it is possible to relax the tensioned state of the submarine cable C when tension is generated in the submarine cable C due to various external forces, and thus the submarine cable C can be protected from various external forces.

Although embodiments of the present disclosure have been described above, it is apparent to those skilled in the art that the present disclosure is not limited to the embodiment disclosed herein and various modifications and changes can be made without departing from the spirit and scope of the present disclosure. Therefore, such modifications and changes should not be individually construed from the spirit or point of view of the present disclosure, and it should be understood that modified embodiments belong to the claims of the present disclosure.

What is claimed is:

1. An underwater trencher having a submarine cable burying apparatus, the underwater trencher comprising:
an underwater moving body; and
a trench digger provided in the underwater moving body by a support plate and a cutter support provided on an upper surface of the underwater moving body,
wherein a cable guide member configured to guide the submarine cable to a trench excavated by the trench digger is coupled to the cutter support, and
an upwardly opened guide portion of the cable guide member is provided with a depressor configured to press downwards the submarine cable drawn into and guided by the cable guide member or to release a pressing force so as to relax a tensioned state of the submarine cable when tension is generated in the submarine cable.

2. The underwater trencher of claim 1, further comprising:
a pair of upper cutter support pieces disposed on an upper surface of one end of the support plate such that the cutter support and a support frame of the trench digger are coupled by a shaft thereto; and
a pair of lower cutter support pieces disposed on a bottom surface of the one end of the support plate such that remaining ends of couple cutter actuators, one ends of which are respectively coupled to opposite sides of the cutter support, are coupled thereto in order to adjust an angle of the trench digger upwards or downwards with reference to the shaft.

3. The underwater trencher of claim 1, wherein at one side of the inlet of the cable guide member, an opening is formed by removing or bending a side wall in order to connect and disconnect the submarine cable when the submarine cable has been drawn into the inlet or while the submarine cable C is being drawn into the inlet.

4. The underwater trencher of claim 1, wherein the depressor comprises:
a push member having one end coupled by a shaft to an upper portion at a side of the inlet of the guide portion and a remaining end as a free end, which turns upwards or downwards within a set angle with reference to the shaft, the push member being formed to have a length equal to or longer than a length of the cable guide member; and
a plurality of push rollers provided on a bottom surface of the push member so as to reduce a frictional force between the push member and the submarine cable drawn into the guide portion and to press the submarine cable downwards.

5. The underwater trencher of claim 4, wherein the depressor further comprises:
a pressing unit configured to relax the tension of the submarine cable supported by the push rollers by raising the push member about the shaft or to tighten the tension of the submarine cable supported by the push rollers by lowering the push member.

6. The underwater trencher of claim 5, wherein the pressing unit comprises:
an actuator, one end of which is coupled by a shaft to the cable guide member and a remaining end is coupled by a shaft to the push member to operate to raise or lower the push member about the shaft; and
a load sensing sensor provided in the actuator, the load sensing sensor being configured to: generate a sensing signal for causing the actuator to operate to raise the push member by sensing tension when the tension is generated in the submarine cable by an external force including buoyancy or tidal current; and generate a sensing signal for causing the actuator to operate to lower the push member by sensing relaxation of the tension when the external force is removed and thus the tension is relaxed.

7. The underwater trencher of claim 5, wherein the pressing unit comprises:
a water tank provided at the remaining end of the push member, and provided with an inlet and an outlet each having a valve; and
a control unit comprising an air pump and a water pump configured to: discharge water accommodated in the water tank and introduce air into the water tank when the tension is generated in the submarine cable by an external force including buoyancy or tidal current so as to reduce a weight of the water tank; and to introduce water into the water tank when the tension acting on the submarine cable has been lost so as to increase the weight of the water tank.

8. The underwater trencher of claim 7, wherein each of the push rollers is provided with a tension sensing sensor configured to sense a load applied to a shaft of the push roller when the external force acts on the submarine cable and the control units performs control based on the sensing signal output from the tension sensing sensor.

9. The underwater trencher of claim 1, further comprising:
a guide member provided on an upper surface of the underwater moving body, the guide member having a guide hole configured to support and guide the submarine cable to the guide portion.

10. A method of installing a submarine cable, the method comprising:
placing an underwater trencher on a sea floor, wherein the underwater trencher comprises an underwater vehicle body, a trench digger and a cable guide, wherein the trench digger and the cable guide are coupled to the underwater vehicle body, wherein the cable guide comprises an elongated body and a depressor coupled to the guide body to form together an elongated, inclined guide channel that comprises a cable inlet and a cable outlet, wherein the depressor is movable with respect to the elongated body;
operating the underwater trencher on the sea floor such that the trench digger digs a trench into the sea floor while the underwater vehicle body travels on the sea floor;
supplying a submarine cable from a cable supply ship on a sea surface to the sea floor through the elongated, inclined guide channel while the depressor presses down the submarine cable in the elongated, inclined guide channel not to float out of the channel;
monitoring force applied to the submarine cable,
when the force is greater than a predetermined value, releasing the submarine cable from the depressor to allow the submarine cable to float out of the channel.

11. The method of claim 10, further comprising:
further monitoring force applied to the submarine cable in a state that the submarine cable is released from the depressor; and
when the force is smaller than another predetermined value which is smaller than or equal to the predetermined value, pressing the submarine cable by the depressor.
